(19) United States
(12) Patent Application Publication
(10) Pub. No.: US 2025/0253320 A1
(43) Pub. Date: Aug. 7, 2025

(54) FeSe2 AND N, S DOPED CARBON SPHERE MICRO FLOWER COMPOSITE AS A HIGH-PERFORMANCE ANODE MATERIAL FOR LITHIUM-ION BATTERY

(71) Applicant: Council of Scientific & Industrial Research, New Delhi (IN)

(72) Inventors: Manjusha Vilas SHELKE, Pune (IN); Apurva Algesh PATRIKE, Pune (IN)

(21) Appl. No.: 18/855,926

(22) PCT Filed: Apr. 10, 2023
(86) PCT No.: PCT/IN2023/050345

§ 371 Date: Oct. 10, 2024

(30) Foreign Application Priority Data
Apr. 12, 2022 (IN) 202211021995

(51) Int. Cl. H01M 4/36; C01B 32/05; H01M 4/58; H01M 4/587; H01M 50/109

(52) U.S. Cl. CPC H01M 4/366; C01B 32/05; H01M 4/581; H01M 4/587; H01M 50/109; C01P 2002/85; C01P 2004/03; C01P 2004/32; C01P 2004/61; C01P 2004/80; C01P 2006/40

(57) ABSTRACT

The present invention relates to an anodic material for use in lithium ion battery (LIB) comprising of FeSe₂ and its carbon composite with N, S doped porous carbon spheres (PNSCS) which can be synthesised by hydrothermal route using iron ammonium sulphate, selenium powder and citric acid as precursors and used as an anode for LIB. Further, the invention provides a process for synthesizing the said FeSe₂ a PNSCS micro-flower composite by simple hydrothermal route.

### FIELD OF THE INVENTION

The invention generally relates to component(s) of electrochemical device or battery specifically Lithium-ion battery (LIB). Particularly, the present invention relates to a composite material for a battery/electrochemical device comprising FeSe₂ with nitrogen and sulphur co-doped porous carbon spheres (FeSe₂@PNSCS). The present invention is also relates to a process of preparation of said composite material comprising FeSe₂ with nitrogen and sulphur co-doped porous carbon spheres. More particularly, the present invention relates to an electrode/anode comprising said FeSe₂ with nitrogen and sulphur co-doped porous carbon spheres, for a battery/electrochemical device. Also, the present invention relates to use of ferroselite (FeSe₂) based anode as high energy lithium-ion battery electrode.

### BACKGROUND OF THE INVENTION

In view of the major environmental crisis being faced by the modern world due to our excessive dependence on polluting fuels over the past several decades, enhancing the use of clean and renewable energy sources in meeting our energy demands has become imperative for our sustainable future. With the fast progress of economy, the environmental problems are increasingly noticeable due to the excessive use of fossil energy, and the demand of people for clean and renewable energy is predominantly crucial.

However, there is serious structure destruction while cycling and irreversible capacity loss is still a big challenge for their practical application. Therefore, it is amply clear that, unless inexpensive, robust, and durable energy storage mechanisms are developed in parallel, large-scale implementation of clean energy initiatives is not feasible.

Lithium-ion battery (LIB) is the most popular and well-optimised to modern technology. But still some study need to be done in terms of cost, durability and safety controls. To the date, graphite is well studied as an anode for lithium-ion battery due to easy Lit insertion into its layer. Later spinel Li₄Ti₅O₁₂ has come into scenario as anode for LIB due to its relatively high Li⁺ insertion voltage (1.5 V with respect to Li) than graphite. However, its low theoretical capacity (175 mAhg⁻¹) limits its use as an anode.

Transition metal chalcogenides conversion materials fit well in these criteria of providing high capacity with relatively more Li⁺ insertion potential to work as an anode. Selenium is from same group of oxygen and sulphur has lower electronegativity which holds good for transition metal selenides to work as an anode material. Transition metal selenides have more electrical conductivity, better rate performance and good cycle life as compared with transition metal oxides.

Research is going on SnSe₂, CoSe₂, FeSe₂, GeSe₂, Sb₂Se₃, etc. transition metal selenides for use as anodes in LIB. L. Q. Mai et al. investigated ferroselite as high energy lithium-ion battery electrode where lithiated FeSe₂ shows capacity of 242 mAhg⁻¹ after 25 cycles with 62.6% capacity retention rate. This lower performance further improved by decorating FeSe₂ with carbon based supports like rGO, CNT, graphitic carbon, etc. The comparative table 1 is provided in this specification which further clarifies the difference between these composites and composite as covered in present invention.

Further, CN101051683 discloses use of antimony triselenide (Sb₂Se₃) as anode material of lithium ion batteries. In case of Sb₂Se₃, pulsed laser deposition has been used as synthesis route. On the other hand, in case of present prior art a simple hydrothermal route is used. Sb₂Se₃ used as anode in CN101051683 has shown a stable performance only up to 100 cycles.

Furthermore, Hierarchical Li₄Ti₅O₁₂—TiO₂ composite microsphere consisting of nanocrystals in high-power Li-ion batteries by Jin-Yun Liao et al. in Electrochimica Acta of 2013 where he discloses a highly mesoporous lithium titanate hierarchical microspheres (LTO-HS) consisting of nanosized octahedron-like crystals were innovatively designed as high performance and safe anode materials for lithium ion battery applications. However, the reported capacity values for this hierarchical Li₄Ti₅O₁₂—TiO₂ composite is much lesser than the present invention based on FeSe₂@PNSCS.

Furthermore, Rupali S. Mehare et al., Electrochem. Sci. Adv. 2021; 1: e2000021 reports a micrometer size activated porous carbon spheres doped with nitrogen and sulfur (NSAPC), which is synthesized hydrothermally at 180° C. for 24 h by using saccharose as the carbon precursor and l-cysteine as the doping agent in a 5:1 ratio, followed by KOH activation. To induce porosity in the as-prepared hydrochar material, it is mixed with KOH in the weight ratio of 1:3 and heated at 800° C. under Ar flow for 1 h. Finally, the material was dried overnight to get N and S doped activated porous carbon spheres. However, this only discloses preparation and electrochemical testing of N and S doped carbon spheres. However, the present invention is based on the electrochemical performance of combination of FeSe₂ with PNSCS based composite for Li ion battery (LIB).

As SnSe₂, CoSe₂, GeSe₂, Sb₂Se₃ are not only difficult to procure but are cost-ineffective and are also not environment friendly. Therefore, there is still a need to develop an anodic material that is cost-effective and eco-friendly along with having better or effective capacity and stability.

Considering the above mentioned drawbacks, the current inventors have developed a novel anode material for lithium-ion battery.

### OBJECTIVES OF INVENTION

In view of the above, the primary objective of the invention is to provide a composite material for a battery/electrochemical device comprising FeSe₂ with nitrogen and sulphur co-doped porous carbon spheres.

Another objective of the present invention is to provide a process of preparation of said composite material comprising FeSe₂ with nitrogen and sulphur co-doped porous carbon spheres.

Another objective of the present invention is to provide an electrode comprising FeSe₂ with nitrogen and sulphur co-doped porous carbon spheres, for a battery/electrochemical device.

Yet another objective of the present invention is to provide an anode comprising FeSe₂ with nitrogen and sulphur co-doped porous carbon spheres, for a battery/electrochemical device.

Yet another objective of the invention is to provide a composite material as an anode material for lithium-ion battery as a charge storage device.

Still another objective of the invention is to provide a composite material/anode material for battery or electrochemical device (e.g. Li ion battery, etc.), where the material has Li⁺ insertion voltage in the range of 1.1-1.5 V to avoid dendrite formation and solid electrolyte interface (SEI) layer simultaneously having high capacity with good cycling life.

Still another objective of the invention is to provide an alternate electrode/anode with superior specific capacity as compared with carbon/graphite.

### SUMMARY OF THE INVENTION

In view of above objectives, the present invention provides a composite comprising FeSe₂ with N, and S doped porous carbon spheres (FeSe₂@PNSCS).

In one aspect, the present invention provides a composite material comprising of iron selenide (FeSe₂) with N and S-codoped porous carbon spheres (FeSe₂@PNSCS), wherein the composite is in the form of micro-flowers having particle size of 7 μm to 8 μm.

Here, N and S co-doped carbon sphere is act as a conducting matrix.

In another aspect, the composite comprises FeSe₂ wrapped over the surface of PNSCS with uniform distribution.

In another aspect, the present invention relates to a composite material for anode electrode in Li ion battery, the composite comprising; FeSe₂ with porous N and S-codoped carbon spheres (PNSCS); wherein said FeSe₂ is decorated onto said N and S-codoped carbon spheres (PNSCS); and wherein said composite is in the form of micro-flowers having particle size in the range of 7 to 8 μm.

Specifically, the FeSe₂ is wrapped over the surface of PNSCS with uniform distribution in said composite.

In another aspect, the amount of elemental carbon is 50-60 atomic %, amount of elemental iron is 12-1614.5 atomic %, and amount of elemental selenium is 24-32 atomic % of the total composition of composite.

In specific aspect, the amount of elemental carbon is 55.5 atomic %, amount of elemental iron is 14.5 atomic %, and amount of elemental selenium is 30 atomic % of the total composition of composite.

In another aspect, the amount of elemental carbon is 15 to 20 wt. %, amount of elemental iron is 15 to 25 wt. %, and amount of elemental selenium is 55 to 65 wt. % of the total composition of composite.

In another aspect, the composite exhibits specific capacity of 350-450 mAhg⁻¹ after 1000 cycles at 1 Ag⁻¹ as anode in Li ion battery.

In another aspect, the invention provides a process for synthesizing the said FeSe₂@PNSCS micro-flower composite by a simple hydrothermal route.

In another aspect, the present invention relates to a process for preparation of the composite, comprising steps of:
a. stirring and dissolving sugar in a 1^{st} solvent followed by addition of an amino acid;
b. hydrothermally heating the solution of step a) at temperature in the range of 160 to 200° C. for a time period of 20 to 26 hrs followed by cooling down the solution at temperature of 25 to 30° C.;
c. washing the solution of step b) with a 2^{nd} solvent under a vacuum filtration followed by drying at a temperature in range of 70-100° C. for a time period of 8 to 14 hrs;
d. annealing the material of step c) at a temperature in range of 780 to 820° C. in for time period of 1-1.30 hrs to obtain a N and S doped carbon spheres (NSCS);
e. subjecting the NSCS of step d) with a KOH solution at a ratio in the range of 1:2 to 1:4 to obtain mixture;
f. thermally treating the mixture of step e) at a temperature in range of 780 to 820° C. with ramp rate of 5° C. for time period of 1 hr;
g. cooling down the mixture of step f) at temperature ranging from 25-30° C. followed by removing KOH through a filtration to obtain porous NSCS (PNSCS) particles;
h. drying the PNSCS particles of step g) at temperature in range of 70-90° C. in an oven for time period of 10-14 hrs;
i. adding and stirring a mixture comprising an iron ammonium sulphate, a Se powder, a citric acid and said dried PNSCS of step h) in a 3^{rd} solvent for a time period of 20 to 45 minutes;
j. dropwise adding a hydrazine hydrate to the mixture of step i) under stirring for time period of 20 to 40 minutes followed by sonication for time period of 45 to 90 minutes;
k. autoclaving the solution of step j) followed by heating at temperature in the range of 160 to 200° C. for time period of 10 to 14 hrs; and
l. washing the solution of step k) with a 4^{th} solvent to obtain a clear solution followed by drying the solution at temperature in the range of 60 to 100° C. for time period of 10 to 14 hrs to obtain the composite.

In another aspect, the 1^{st}, 2^{nd}, 3^{rd} and 4^{th} solvents are independently selected from de-ionized water, ethanol or mixture thereof.

In another aspect, the washing steps c) and l) is done by first treating with de-ionized water followed by mixture of de-ionized water and ethanol.

In another aspect, the sugar in step a) is selected from saccharose, glucose, or fructore. In another aspect of the present invention, the solvent used in step a) is selected from water, and mixture of ethanol and water. The mixture of ethanol and water may be taken in a ratio of 1:1, 1:2 or 2:1.

In another aspect of the present invention, the amino acid is selected from L-cysteine, methionine, or alanine.

In another aspect of the present invention, the solvent for washing in step c) is done by first washing with de-ionized water followed by second washing with ethanol.

In another aspect of the present invention, the solvent used in step i) and m) is selected from Deionized water, or mixture of DI H₂O and ethanol.

In another aspect, the size of the FeSe₂@PNSCS composite obtained is 7 to 8 μm.

In another aspect, the present invention relates to a full coin cell comprising:
a) FeSe₂@PNSCS as claimed in claim 1 as an anode;
b) a cathode,
c) a separator,
d) an electrolyte,
e) a spacer,
f) a spring, and
e) metallic casing;
   wherein the full coin cell has stability for up to 150-250 cycles at 0.1 C rate with capacity value of 15-20 mAhg⁻¹.

Said FeSe₂@PNSCS micro-flowers are manufactured by simple hydrothermal route using iron ammonium sulphate, selenium powder and citric acid as precursors. The material displays impressive performance with reversible capacity of 702 mAh g⁻¹ at 500 mAg⁻¹ current density value even after 100 cycles. Further, the FeSe₂@PNSCS anode of the invention is stable up to 500 cycles.

In another aspect of the present invention, the FeSe₂@PNSCS composite is used as an anode for Li-ion batteries.

In another aspect of the present invention, the FeSe₂@PNSCS micro-flowers composite exhibits specific capacity of 350-450 mAhg⁻¹ even after 1000 cycles.

In another aspect, the present invention provides a battery comprising of FeSe₂ and N, S doped porous carbon spheres (FeSe₂@PNSCS) micro-flowers electrode as prepared by the process as disclosed herein.

### BRIEF DESCRIPTION OF THE DRAWINGS

FIG. 1: ESEM images for (a) FeSe₂, (b) PNSCS, (c) and (d) FeSe₂@PNSCS, and (e) illustrates EDX spectra for prepared FeSe₂@PNSCS.

FIG. 2: demonstrates phase purity of as prepared FeSe₂ and FeSe₂@PNSCS micro-flower composites confirmed by p-XRD, where all peaks are well matching with FeSe₂ JCPDS No. 79-1892 showing orthorhombic phase of FeSe₂.

FIG. 3: LIB testing performance study of FeSe₂@PNSCS in 1 M LiPF₆ in EC/DMC with 5% FEC. (a) Cyclic voltammogram comparison for FeSe₂ and FeSe₂@PNSCS, (b) Rate performance study of FeSe₂@PNSCS, (c) Cycling stability of FeSe₂@PNSCS at 1 Ag⁻¹ and (d) cycling stability comparison of FeSe₂ and FeSe₂@PNSCS at 0.5 Ag⁻¹.

FIG. 4: Capacitive and diffusion-controlled contributions of FeSe₂@PNSCS calculated from CV scans. (a) CV at different scan rates, (b) plot of log (current, i) vs log (scan rate, v), (c) i/v^{1/2} vs v^{1/2} and (d) normalized contribution ratio of capacitive and diffusion-controlled capacities at different scan rates.

FIG. 5: Li ion battery full cell comprised of FeSe₂@PNSCS as anode and LiFePO₄ as cathode. (a) Rate performance study and (b) Cycling stability at 0.1 C rate.

FIG. 6: A coin cell assembly with said FeSe₂@PNSCS micro-flower composite as anode.

### DETAILED DESCRIPTION OF THE INVENTION

The terms “ferroselite” or “FeSe₂” are used interchangeably throughout the specification, and the same means an orthorhombic-pyramidal mineral containing iron, magnesium, oxygen, and silicon; or an orthorhombic ferroselite and its isometric polymorph dzharkenite are iron selenides of general formula FeSe₂ precipitated under reducing conditions in anoxic environments.

The expressions, “ambient temperature” and “room temperature” or “rt” as used herein, are understood in the art, and refer generally to a temperature, e.g. a reaction temperature, that is about the temperature of the room in which the reaction is carried out, for example, a temperature from about 20° C. to about 30° C.

Described herein is a FeSe₂ and N. S doped porous carbon spheres (FeSe₂@PNSCS) micro-flowers composite used as a high-performing anode material for Li-ion battery. The synthesis of said material is also described.

In an embodiment, the invention describes an Iron-based material which are beneficial for LIB, since iron is more abundant in nature, cost effective and environmentally friendly.

In an embodiment, the present invention provides a composite material comprising of a FeSe₂ with N and S-doped porous carbon spheres, wherein the FeSe₂ and N, S doped porous carbon spheres are formulated in the form of (FeSe₂@PNSCS) micro-flowers composite having size of 7 μm to 8 μm.

In accordance with the above embodiment, the invention describes a FeSe₂@PNSCS micro-flower composite anode which is used in Li-ion batteries for improved performance. Said anodic material is synthesised through a simple hydrothermal route and used as high energy anode material for lithium-ion batteries.

The FeSe₂ micro-flowers have been synthesized by simple hydrothermal route and achieve high capacity of 702 mAhg⁻¹ at 500 mAg⁻¹ current density after 100 cycles. However, within 500 cycles bare FeSe₂ shows degraded performance while capacity for FeSe₂@PNSCS is much improved to 1329 mAhg⁻¹ after 500 cycles. This improved capacity is attributed to composite with CSs more particularly with N and S doped CSs. PNSCS provides conducting support to bare FeSe₂ for charge and ionic transport. The doped carbon i.e. N and S doped carbon spheres support the conduction matrix for FeSe₂ to avoid the capacity fading of bare FeSe₂.

In another embodiment, the present invention provides a process for preparation of a FeSe₂ and N, S doped porous carbon spheres (FeSe₂@PNSCS) micro-flowers composite comprising steps of:
1) synthesis of a N and S doped CS
   a. stirring and dissolving 9-11 gm of sugar in a solvent followed by addition of 1-3 gm of an amino acid;
   b. hydrothermally heating the solution of step a) at temperature in range of 160 to 200° C. for time period of 20 to 26 hrs followed by cooling down the solution at temperature of 25-30° C.;
   c. washing the product of step b) with solvent under a vacuum filtration followed by drying at temperature in range of 70-100° C. for time period of 8 to 14 hrs;
   d. annealing the material of step c) at temperature in range of 780 to 820° C. in for 1-1.30 hrs to obtain 1-3 gm of N and S doped carbon spheres (NSCS);
2) synthesis of Porous NSCS
   e. subjecting the NSCS to a KOH solution with a ratio in the range of 1:2-1:4;
   f. thermally treating the mixture of step e) at temperature in range of 780 to 820° C. with ramp rate of 5° C. for 1 hr;
   g. cooling down the mixture of step f) at 25-30° C. followed by removing KOH through filtration to obtain porous NSCS (PNSCS) particles;
   h. drying the PNSCS at temperature in range of 70-90° C. in oven for 10-14 hrs;
3) synthesis of FeSe₂@PNSCS composite:
   i. adding 0.6-0.8 gm of Iron ammonium sulphate, 0.2-0.4 gm of Se powder, 3-4 gm of a citric acid, and 100-150 mg of PNSCS (116 mg) as synthesized to 40-50 ml of solvent;
   j. stirring the mixture of step i) for time period of 20 to 45 minutes;
   k. dropwise adding 12-18 ml hydrazine hydrate to the mixture of step j) under stirring for 20 to 40 minutes followed by sonication for 45 to 90 minutes;
   l. autoclaving the solution of step k) followed by heating at temperature in the range of 160 to 200° C. for time period of 10 to 14 hrs; and
   m. washing with solvent to obtain a clear solution followed by drying the solution at temperature in the range of 60 to 100° C. for time period of 10 to 14 hrs.

In an embodiment of the present invention, the solvent used in step a) is selected from water ethanol or mixture thereof.

In an embodiment of the present invention, the amino acid is selected from L-cysteine, methionine, or alanine.

The solvent for washing in step c) is done by first washing with de-ionized water followed by second washing with ethanol.

In an embodiment of the present invention, the solvent used in step j) and n) is selected from DI water, or mixture of DI H₂O and ethanol.

In an embodiment of the present invention, the size of composite FeSe₂@PNSCS is 7-8 μm. In an embodiment of the present invention, the FeSe₂@PNSCS micro-flowers composite is used as an anode for Li-ion batteries.

In an embodiment of the present invention, the FeSe₂@PNSCS micro-flowers composite exhibits specific capacity of 350-450 mAhg⁻¹ even after 1000 cycles.

In another embodiment of the present invention provides a full cell comprising of: FeSe₂@PNSCS as claimed in claim 1 of the present invention as an anode, LiFePO₄ as cathode, and wherein the full cell has shown stability for 200 cycles at 0.1 C rate with capacity value of 17 mAhg⁻¹.

In an embodiment of the present invention provides a battery comprising of FeSe₂ and N, S doped porous carbon spheres (FeSe₂@PNSCS) micro-flowers electrode as prepared from process given in the present disclosure.

In another aspect, the present invention relates to a full coin cell comprising:
a) FeSe₂@PNSCS
b) a cathode,
c) a separator,
d) an electrolyte,
e) spacer,
f) spring, and
e) metallic casing;
   wherein the full cell has stability for up to 150-250 cycles at 0.1 C rate with capacity value of 15-20 mAhg⁻¹.

In another embodiment, the full coin cell is Li ion based battery cell.

In another embodiment, the cathode is Lithium Iron phosphate (LiFePO₄) or Lithium Cobalt Oxide (LiCoO₂).

In another embodiment, the separator is Quartz fiber paper or Celgard 2500.

In another embodiment, the electrolyte is selected from 1M LiPF₆ in EC:DMC:EMC (1:1:1 by v/v/v) with 5% FEC, 1M LiPF₆ in EC:DMC, and 1M LiPF₆ in EC:DEC.

The metallic casing comprises positive casing and negative casing.

The negative and positive casings of the coin cell battery serve as negative and positive terminal of the battery and are made up of stainless steel. The negative case is equipped with sealant which ensures insulation from positive case.

The spring and spacer of said cell ensures proper packing of the coin cell.

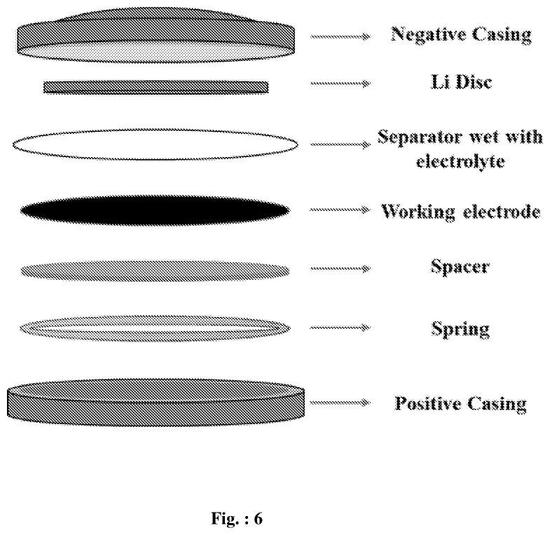

The FIG. 6 shows the schematic of the full coin cell assembly. Negative case made up of stainless-steel acts as negative terminal. The lithium (LiFePO₄) cathode is placed upon the negative case and Quartz fiber paper as a separator is kept above the anode with coating side of anode is facing the separator. The separator is wetted with the electrolyte. The anode is coated with said FeSe₂@PNSCS composite and is in contact with separator and cathode on one side, and spacer on other side. The spacer and spring are then placed below to anode to ensure the tight packing of coin cell. Then positive case is placed above and the coin cell system is cold pressed using hydraulic press to give packed coin cells.

The electrochemical performance of FeSe₂@PNSCS micro-flowers composite was studied 1 M LiPF₆ in EC/DMC/EMC (1:1:1 by v/v/v) with 5% FEC cycling in potential range of 0.01-3 V in 2032-coin cell assembly. Upon composite making with PNSCS, FeSe₂@PNSCS shows a slight increase in anodic and cathodic voltages indicating faster kinetics as compared to bare FeSe₂. Also peak current values for FeSe₂@PNSCS are higher than FeSe₂ represents more charge transport resulting in higher capacity value for FeSe₂@PNSCS.

The Porous nature and N. S dual-doped carbon spheres enhance the electronic conductivity and also provide binding sites for the facile deposition of a large number of FeSe₂ micro-flowers. PNSCS provides the conducting channels for charge and ionic transport. As a result, FeSe₂@PNSCS shows excellent rate performance and long cycle life.

The FeSe₂ is used in a 1:1 ratio with porous N and S doped C spheres to form a composite. Performance of FeSe₂ and composite is compared.

Though FeSe₂ and the composite show 187 mAhg⁻¹ for current density of 1 Ag-1 and 443 mAhg⁻¹ for 2000 and 1000 cycles respectively, some prior arts report greater values, but at lower current density and for lower number of cycles.

FeSe₂ micro-flowers are decorated over porous N and S doped carbon spheres. The composite of FeSe₂ and PNSCS is synthesized using hydrothermal method. This hydrothermal method gives rise to micro-flower morphology. If synthesis method is changed, the morphology will also change.

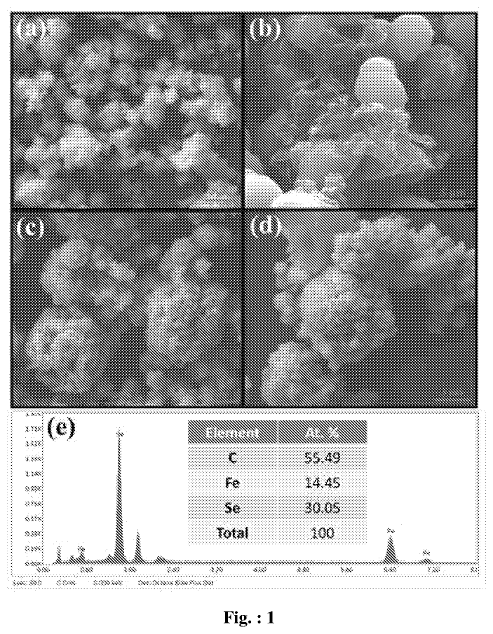

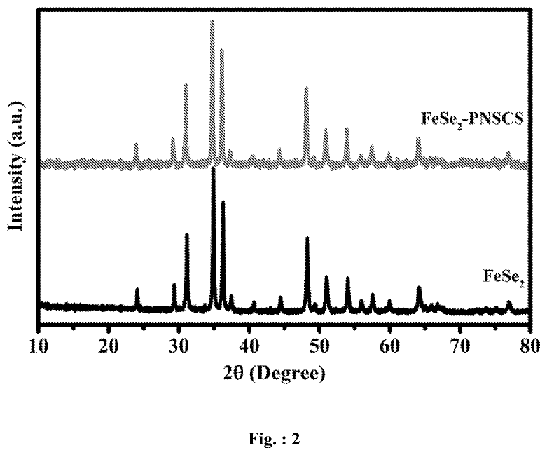

FIG. 1 illustrates the scanning electron micrographs of micro-flower morphology for FeSe₂. PNSCS and FeSe₂ wrapped over the surface of PNSCS respectively. The composite FeSe₂@PNSCS resulted into average size of 7-8 μm. The uniform distribution of FeSe₂ over PNSCS surface is attributed to the presence of N and S heteroatoms doping into CS. FIG. 2 demonstrates the pXRD spectra of FeSe₂ and FeSe₂@PNSCS. The observed peaks match with FeSe₂ JCPDS No. 79-1892 showing orthorhombic phase of FeSe₂. The XRD matches with JCPS, no impurity found, it is pure FeSe₂. It is 1-2 microns in size and morphology appears like flowers. The charge-discharge cycles has been studied @160 cycles, increased capacity observed with gradual increase even if there's low current density. A detailed mechanistic explanation is provided for intermittent increase in capacity. FIG. 1(e) demonstrates EDX spectra for prepared FeSe₂@PNSCS.

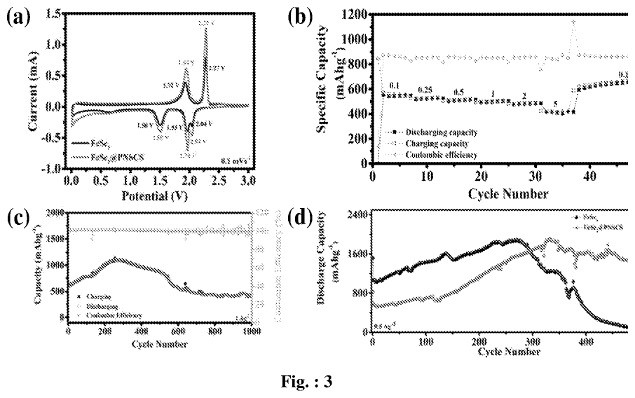

FIG. 3a illustrates the electrochemical performance of FeSe₂@PNSCS micro-flowers composite studied as 1 M LiPF₆ in EC/DMC/EMC (1:1:1 by v/v/v) with 5% FEC cycling in potential range of 0.01-3 V in 2032-coin cell assembly. Cyclic voltammograms of as prepared FeSe₂ and FeSe₂@PNSCS for at scan rate of 0.1 mVs⁻¹ in 0.01-3 V potential range. The two cathodic peaks observed in CV at ˜2 V and 1.5 V represents lithiation and conversion reactions of FeSe₂@PNSCS. In subsequent charging to 3 V, two anodic peaks were observed in CV at 1.94 V and 2.29 V which represents the reverse delithiation of LiFeSe₂ to form FeSe₂. Upon composite making with PNSCS, FeSe₂@PNSCS shows slight increase in anodic and cathodic voltages indicating faster kinetics as compared to bare FeSe₂. Also peak current values for FeSe₂@PNSCS are higher than FeSe₂ indicating more charge transport, resulting in higher capacity value for FeSe₂@PNSCS.

As illustrated in FIG. 3b, the rate performance is carried out at different current densities selected from 0.1 Ag⁻¹, 0.25 Ag⁻¹, 0.5 Ag⁻¹, 1 Ag⁻¹, 2 Ag⁻¹, 5 Ag⁻¹ and 0.1 Ag⁻¹ and capacity values observed were 550, 527, 514, 497, 488, 405 and 608 mAhg⁻¹ respectively. The stable capacity values at such different current rates make FeSe₂@PNSCS a promising material as anode for LIB.

FIGS. 3c and 3d illustrates the long-term cycling of FeSe₂@PNSCS at 0.5 Ag⁻¹ and 1 Ag⁻¹ current density. As can be seen from the FIG. 3c, the anodic material of the invention shows a long term stability of FeSe₂@PNSCS at 1 Ag⁻¹ which shows increase in capacity for initial 250-300 cycles to a certain value and then a small decrease with further stability observed. Since the present material is conversion type one could easily predict partial formation and decomposition of SEI layer. The decomposition of SEI occurs due to catalytic property of metal particles formed during discharging process. Additionally, this increase in capacity for initial some cycle can be explained by opening of structure and giving more space for Li⁺ to accommodate into it while charging and discharging. At 1 Ag⁻¹ FeSe₂@PNSCS exhibited specific capacity of 443 mAhg⁻¹ even after 1000 cycles.

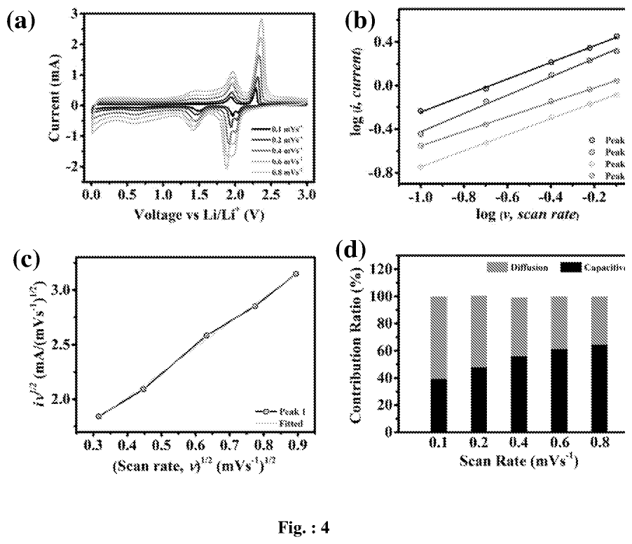

FIG. 4 explains the electrochemical kinetics to find the reason for increased performance in FeSe₂@PNSCS by calculating the capacitive and diffusive contribution to capacity by undertaking CV at different scan rates from 0.1-0.8 mVs⁻¹. For anodic peak at 2.2 V, capacitive contribution is 39%, 48%, 56%, 61%, and 64%, at 0.1, 0.2, 0.4, 0.6, and 0.8 mVs⁻¹ respectively which indicates dominance of surface controlled reaction as scan rate increases.

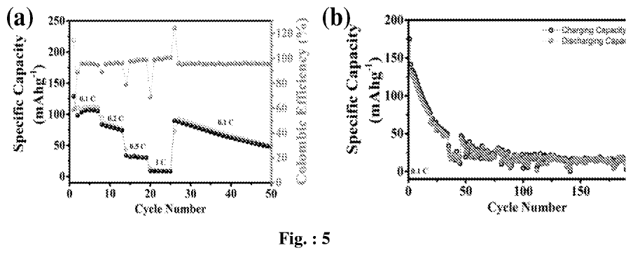

FIG. 5 shows a proof of concept model Li-ion battery full cell comprised of FeSe₂@PNSCS as anode and LiFePO₄ as cathode. Rate performance was carried out at 0.1 C, 0.2 C, 0.5 C, 1 C and 0.1 C current rates (1 C=165 mAg⁻¹) where capacity of 105, 74, 30, 8 and 82 mAhg⁻¹ were achieved at respective current values. The full cell has shown stability for 200 cycles at 0.1 C rate with capacity value of 17 mAhg⁻¹.

FIG. 6 is a representative figure of the present invention.

### EXAMPLES

Following examples are given by way of illustration and therefore should not be construed to limit the scope of the invention.

### Example 1: Synthesis of N, S Doped CS

The synthesis protocol is followed from one of our previously reported work where saccharose and L-cysteine in 5:1 ratio are used as precursors. 10 g of saccharose is first dissolved in 120 ml of de-ionized water followed by the addition of 2 g of L-cysteine under stirring. The resultant solution is then treated hydrothermally at 180° C. for 24 h. After cooling down to room temperature, the obtained product is washed several times with de-ionized water and ethanol by vacuum filtration followed by overnight drying at 80° C. After drying, the as-prepared material is annealed at 800° C. in an inert atmosphere for 1 h.

### Example 2: Synthesis of PNSCS

The as prepared NSCS of Example 1 is subjected to KOH activation in which as prepared NSCS and KOH is taken in 1:3 ratio. The prepared mixture is thermally treated at 800° C. with ramp rate 5° C. in Ar atmosphere for 1 hr. After cooling down to room temperature KOH is removed using 1 M HCl through filtration. PNSCS is obtained after drying at 80° C. in oven for 12 hr.

### Example 3: Synthesis of FeSe₂@PNSCS Micro-Flowers

Iron ammonium sulphate (2 mmol), Se powder (4 mmol), citric acid (20.8 mmol) and PNSCS (116 mg) are added to 44 ml DI water and kept under stirring for half an hour. 16 ml hydrazine hydrate were added dropwise to the solution under stirring and kept this solution for half an hour stirring condition and then for 1 hour sonication. After vigorous stirring and sonication, the solution is transferred to 150 ml Teflon lined stainless steel autoclave and heated to 180° C. for 12 h. After cooling down to room temperature, solution is washed with DI water several times till a clear solution is obtained, to remove metallic Se and other impurities. Finally, the washed sample is dried at 80° C. for 12 h in oven.

### Example 4

### Material Characterization

As prepared FeSe₂ phase was confirmed by powder X-ray diffraction that are carried out on a Philips X'Pert PRO diffractometer with nickel-filtered Cu K_{α} radiation (2=1.5418 Å). The diffractograms were recorded at a scanning rate of 1° min⁻¹ between 10° to 80°. The morphology of the material was established using a high-resolution field emission NOVA NANO SEM system.

### Electrochemical Measurements:

The electrochemical testing of FeSe₂ is done by making 2032-coin type half cells which were fabricated in Ar filled glove box. The working electrode is made by making homogeneous slurry of active material, conducting carbon and carboxyl methyl cellulose as binder in 70:20:10 wt % in NMP solvent. The slurry is coated on Cu foil and dried at 80° C. overnight. LiFePO₄ cathode electrode for Full Cell is made by making homogeneous slurry of LiFePO₄, conducting carbon and PVDF in 80:10:10 ratio wt % in NMP solvent. The slurry is coated on Al foil and dried at 80° C. overnight. Circular electrodes of 14 mm diameter sizes are cut down using electrode cutter. Mass balancing for anode and cathode is performed for full cell electrodes in 1:1 ratio. Li metal chip was used as counter/reference electrode and quartz fiber separator. 1 M LiPF₆ in EC/DMC (1:1 V/V) with 5% FEC is used as electrolyte. The cyclic voltammetry and impedance studies are done by using Bio-Logic VMP3 instrument. Galvanostatic charge discharge measurements are carried out in MTI corporation battery analyser at variable current densities. The working potential for all electrochemical measurements are kept as 0.01-3 V.

### Example 5

A comparative table for various literature reports and also specifically for Li ion battery performance is provided below.

TABLE 1

| | | Current | | | |
|---|---|---|---|---|---|
| Sr. | | density | Capacity | | |
| No. | Material | (Ag⁻¹) | (mAhg⁻¹) | Cycles | Ref |
| 1. | FeSe₂—CNT | 0.5 | 571.2 | 50 | Chem. |
| | | | | | Commun., |
| | | | | | 2019, 55, |
| | | | | | 10960-10963 |
| | | | | | DOI: |
| | | | | | 10.1039/ |
| | | | | | C9CC05069H |
| 2. | FeSe₂@rGO | 0.1 | 945.8 | 100 | J Mater Sci 54, |
| | | | | | 4225-4235 |
| | | | | | (2019). DOI: |
| | | | | | 10.1007/ |
| | | | | | s10853-018- |
| | | | | | 3143-1 |
| 3. | FeSe₂@Fe₂O₃— | 1 | 770 | 1000 | J. Mater. |
| | GC | | | | Chem. A, |
| | | | | | 2018, 6, |
| | | | | | 15182-15190 |
| 4. | FeSe₂ | 0.04 | 242 | 25 | Int. J. |
| | nanoflowers | | | | Electrochem. |
| | | | | | Sci., Vol. 4, |
| | | | | | 2009 |
| 5. | FeSe₂—C/rGO | 0.1 | 917.6 | 100 | Electrochimica |
| | | | | | Acta 323 |
| | | | | | (2019) 1348 |
| 6. | FeSe₂/C | 0.1 | 798 | 100 | ACS Appl. |
| | | | | | Mater. |
| | | | | | Interfaces2018, |
| | | | | | 10, |
| | | | | | 38862-38871 |
| 7. | FeSe₂@PNSCS | 431 | 1 | 1000 | Present |
| | | | | | invention |

### Advantages of the Invention

Lithium-ion battery (LIB) is most popular and well optimised to modern technology having high capacity with good cycling life.
Further, Iron is more abundant in nature, cost effective and environmentally friendly.
The FeSe₂@PNSCS micro-flower composite anode of the invention anode improves Li-ion batteries performance.
The present invention is based on the high performance anode material comprised of FeSe₂@PNSCS composite for LIB application.

1. A composite comprising:
FeSe₂ with porous N and S-codoped carbon spheres PNSCS, wherein said FeSe₂ is decorated onto said N and S-codoped carbon spheres PNSCS;
wherein said composite is in the form of micro-flowers having a particle size in the range of 7 to 8 μm.

2. The composite as claimed in claim 1, wherein the FeSe₂ is wrapped over the surface of PNSCS with uniform distribution.

3. The composite as claimed in claim 1, wherein an amount of elemental carbon is 50-60 atomic %, an amount of elemental iron is 12-16 atomic %, and an amount of elemental selenium is 24-32 atomic % of the total composition of composite; and wherein an amount of elemental carbon is 15 to 20 wt. %, an amount of elemental iron is 15 to 25 wt. %, and an amount of elemental selenium is 55 to 65 wt. % of the total composition of composite.

4. The composite as claimed in claim 1, wherein the composite exhibits specific capacity of 350-450 mAhg⁻¹ after 1000 cycles at 1 Ag⁻¹.

5. The composite as claimed in claim 1, for use as an anode electrode in a Li ion battery.

6. A process for preparation of the composite as claimed in claim 1, comprising:
a) stirring and dissolving sugar in a 1^{st} solvent followed by addition of an amino acid;
b) hydrothermally heating the solution of step a) at a temperature in a range of 160 to 200° C. for a time period of 20 to 26 hrs followed by cooling down the solution at a temperature of 25 to 30° C.;
c) washing the solution of step b) with a 2^{nd} solvent under a vacuum filtration followed by drying at a temperature in a range of 70-100° C. for a time period of 8 to 14 hrs;
d) annealing the material of step c) at a temperature in a range of 780 to 820° C. for time a period of 1-1.30 hrs to obtain a N and S doped carbon spheres (NSCS);
e) subjecting the NSCS of step d) with a KOH solution at a ratio in a range of 1:2 to 1:4 to obtain a mixture
f) thermally treating the mixture of step e) at a temperature in a range of 780 to 820° C. with a ramp rate of 5° C. for a time period of 1 hr;
g) cooling down the mixture of step f) at a temperature ranging from 25-30° C. followed by removing KOH through a filtration to obtain porous NSCS (PNSCS) particles;
h) drying the PNSCS particles of step g) at a temperature in a range of 70-90° C. in an oven for a time period of 10-14 hrs;
i) adding and stirring a mixture comprising an iron ammonium sulphate, a Se powder, a citric acid and said dried PNSCS of step h) in a 3^{rd} solvent for a time period of 20 to 45 minutes;
j) dropwise adding a hydrazine hydrate to the mixture of step i) under stirring for a time period of 20 to 40 minutes followed by sonication for a time period of 45 to 90 minutes;
k) autoclaving the solution of step j) followed by heating at a temperature in a range of 160 to 200° C. for a time period of 10 to 14 hrs; and
l) washing the solution of step k) with a 4^{th} solvent to obtain a clear solution followed by drying the solution at a temperature in a range of 60 to 100° C. for a time period of 10 to 14 hrs to obtain the composite.

7. The process as claimed in claim 6, wherein the 1^{st}, 2^{nd}, 3^{rd} and 4^{th} solvents are independently selected from de-ionized water, ethanol or mixture thereof; and wherein the washing steps c) and l) is done by first treating with de-ionized water followed by a mixture of de-ionized water and ethanol.

8. The process as claimed in claim 6, wherein the amino acid is selected from L-cysteine, methionine, or alanine.

9. The process as claimed in claim 6, wherein the sugar in step a) is selected from saccharose, glucose, or fructose.

10. The process as claimed in claim 6, wherein a size of the FeSe₂@PNSCS composite obtained is 7 to 8 μm.

11. A full coin cell comprising:
a) FeSe₂@PNSCS as claimed in claim 1 as an anode;
b) a cathode;
c) a separator;
d) an electrolyte;
e) spring;
f) spacer; and
g) a metallic casing.

12. The full coin cell as claimed in claim 11, wherein the full coin cell has stability for up to 150-250 cycles at 0.1 C rate with a capacity value of 15-20 mAhg⁻¹.

13. The full coin cell as claimed claim 11, wherein the cell is a Li ion based battery.

14. The full coin cell as claimed claim 11, wherein the cathode is Lithium Iron phosphate (LiFePO₄) or Lithium Cobalt Oxide (LiCoO₂); the separator is Quartz fiber paper or Celgard 2500; and the electrolyte is selected from 1M LiPF₆ in EC:DMC:EMC (1:1:1 by v/v/v) with 5% FEC, 1M LiPF₆ in EC:DMC, and 1M LiPF₆ in EC:DEC
